(19) United States
(12) Patent Application Publication
(10) Pub. No.: US 2026/0099554 A1
(43) Pub. Date: Apr. 9, 2026

(54) METHOD AND APPARATUS FOR SEARCHING MULTI-VECTOR USING SPAN-LEVEL SEQUENCE COMPRESSION TECHNIQUE

(71) Applicant: SK TELECOM CO., LTD., Seoul (KR)

(72) Inventors: Cheon Eum PARK, Seoul (KR); Kyung Lang PARK, Seoul (KR); Soon Woong LEE, Seoul (KR); Yong Hun LEE, Seoul (KR); Seung Min HEO, Seoul (KR)

(21) Appl. No.: 19/415,303

(22) Filed: Dec. 10, 2025

Related U.S. Application Data
(63) Continuation of application No. PCT/KR2024/015562, filed on Oct. 15, 2024.

(30) Foreign Application Priority Data
Oct. 18, 2023 (KR) 10-2023-0139262

(51) Int. Cl. G06F 16/93

(52) U.S. Cl. CPC G06F 16/93

(57) ABSTRACT

An apparatus according to an embodiment of the present disclosure comprises: at least one memory for storing instructions; and at least one processor. The at least one processor is configured to execute the instructions to perform the steps of: generating a span including a span index for an arbitrary document token; encoding an input query token to generate a query token encoding vector; encoding a document token; generating a document token encoding vector; compressing the document token encoding vector into a span vector according to the span index and outputting the compressed document token encoding vector; and searching for a document token encoding vector having the highest similarity to the query token encoding vector by calculating a score between the query token encoding vector and the compressed document token encoding vector.

### CROSS-REFERENCE TO RELATED APPLICATION

The present application is a continuation of International Application No. PCT/KR2024/015562, filed Oct. 15, 2024, which is based upon and claims priority to Korean Patent Application No. 10-2023-0139262, filed in the Republic of Korea on Oct. 18, 2023, which is incorporated herein by reference in its entirety.

### TECHNICAL FIELD

The present disclosure relates to a method and apparatus for searching multi-vector using span-level sequence compression technique.

### BACKGROUND

The content described in this section merely provides background information for the present invention and does not constitute prior art.

Recently, with the advancement of machine learning technologies such as deep learning, Natural Language Processing (NLP) has attracted significant attention. Natural language processing is a technology that enables a computer to recognize and process language, and is used in various fields such as automatic translation and search engines. Representative algorithms used in NLP include Bidirectional Encoder Representations from Transformers (BERT) and Generative Pre-Training model (GPT).

BERT is a natural language processing model published by Google in 2018. The model was first introduced in a paper describing language representation using a transformer neural network structure. Here, language representation refers to a scheme of converting human language into a multi-dimensional vector that may be understood by a computer. BERT is a model that pre-trains large amounts of unlabeled text data from Wikipedia, other encyclopedias, books, papers, and academic materials. In this process, BERT uses a neural network structure to learn language patterns and context from large amounts of text. Thereafter, BERT is fine-tuned through transfer learning using a labeled data set tailored to a specific task.

Meanwhile, Contextualized Late Interaction over BERT (ColBERT) is a BERT-based ranking model that supports a much faster search speed than BERT while providing quality as good as BERT. In ColBERT, a token-by-token relevance score is calculated based on a sum-of-max score (or MaxSim) function.

A single-vector search method calculates the similarity between a query and a document using a single vector. In contrast, a multi-vector search method is a method of generating as many vectors as the number of input tokens and calculating, for each token, similarity between the query and the document.

The multi-vector search method provides better performance than the single-vector search method, but has a problem of requiring a large amount of memory space and a large amount of computation. For example, when indexing a collection, if a document length is fixed at 512 tokens, the total size of vectors required for indexing becomes 1000000*512*128 (collection size*document length*number of vector dimensions). This vector size requires about 244 GB of memory. Additionally, there is a problem of information loss when performing sequence compression.

### SUMMARY

The present disclosure provides a method and apparatus for reducing a memory space and an amount of computation in multi-vector search method.

The present disclosure provides a method and apparatus for performing encoding on given document tokens by an encoder, and then dividing the encoded document tokens into windows having a predetermined length (in span units), and compressing the windows into a single vector, and using the single vector for search.

The present disclosure provides a method and apparatus for minimizing information loss that occurs when compressing the length of an input sequence during collection indexing.

The problems to be solved by the present invention are not limited to the problems mentioned above, and other problems not mentioned will be clearly understood by those skilled in the art from the description below.

According to one aspect of the present disclosure, there is provided an apparatus for searching multi-vector using a span-level sequence compression technique, comprising: at least one memory storing instructions; and at least one processor, wherein the at least one processor is configured to execute the instructions to: generate a span comprising a span index for any document token; encode an input query token to generate a query token encoding vector; encode the document token to generate a document token encoding vector; compress the document token encoding vector into a span vector according to the span index to output a compressed document token encoding vector; and calculate a score between the query token encoding vector and the compressed document token encoding vector and retrieve a document token encoding vector having the highest similarity to the query token encoding vector.

According to another aspect of the present disclosure, there is provided a computer-implemented method comprising: generating a span comprising a span index for any document token; encoding an input query token to generate a query token encoding vector; encoding the document token to generate a document token encoding vector; compressing the document token encoding vector into a span vector according to the span index to output a compressed document token encoding vector; and calculating a score between the query token encoding vector and the compressed document token encoding vector and retrieving a document token encoding vector having the highest similarity to the query token encoding vector.

The present disclosure may reduce memory usage and computational requirements in a multi-vector search method.

The present disclosure may minimize information loss when performing sequence compression.

The present disclosure may reduce loss of information even when compressing a length of an input sequence when indexing a collection.

The present disclosure may reduce a length of a document in a collection from 512 tokens to a parameter-defined length.

The present disclosure may be executable even on servers with a small memory capacity.

The effects of the present disclosure are not limited to the effects mentioned above, and other effects not mentioned will be clearly understood by those skilled in the art from the description below.

### BRIEF DESCRIPTION OF THE DRAWINGS

FIG. 1 is an exemplary diagram illustrating a method for searching multi-vector based on a ColBERT model.

FIG. 2 is an exemplary diagram illustrating a MaxSim operation based on the ColBERT model.

FIG. 3 is a flowchart illustrating a method for searching multi-vector using a span-level sequence compression technique according to an embodiment of the present disclosure.

FIG. 4 is an exemplary diagram illustrating a process of indexing a collection according to an embodiment of the present disclosure.

FIG. 5 is a structural diagram of an apparatus for searching multi-vector using a span-level sequence compression technique according to an embodiment of the present disclosure.

FIG. 6 is an exemplary diagram illustrating a search system pipeline to which a search algorithm according to another embodiment of the present disclosure is applied.

### DETAILED DESCRIPTION

Hereinafter, some embodiments of the present disclosure will be described in detail with reference to the exemplary drawings. It should be noted that in assigning reference numerals to the components of each drawing, the same components are given the same reference numerals as much as possible even though they are shown in different drawings. In addition, in describing the present disclosure, when it is determined that a detailed description of a related known configuration or function may obscure the gist of the present disclosure, the detailed description thereof will be omitted.

In addition, in describing the components of the present disclosure, terms such as first, second, A, B, (a), and (b) may be used. These terms are only for distinguishing the component from other components, and the nature, order, or sequence of the component is not limited by the terms. Throughout the specification, when a part is said to “include” or “comprise” a component, this means that it may further include other components rather than excluding other components unless specifically stated to the contrary. In addition, terms such as “unit” and “module” described in the specification mean a unit that processes at least one function or operation, which may be implemented by hardware, software, or a combination of hardware and software.

The detailed description to be disclosed below together with the accompanying drawings is intended to describe exemplary embodiments of the present disclosure, and is not intended to represent the only embodiments in which the present disclosure may be practiced.

In this specification, a query refers to a query input by a user, a document refers to a target document to be retrieved by the user, and collection refers to a set of all documents. Here, the query may be used in training data and inference step.

In this specification, a query token encoding vector and a query token vector have the same meaning and will be used interchangeably.

In this specification, a document token encoding vector and a document token vector have the same meaning and will be used interchangeably.

An embodiment of the present disclosure provides a method for compressing sequence information in span units to solve problems of token-level multi-vector search method. In addition, the embodiment of the present disclosure may encode given document tokens using an encoder, then divide the encoded document tokens into windows having a predetermined length and compress the windows into a single vector for use in search.

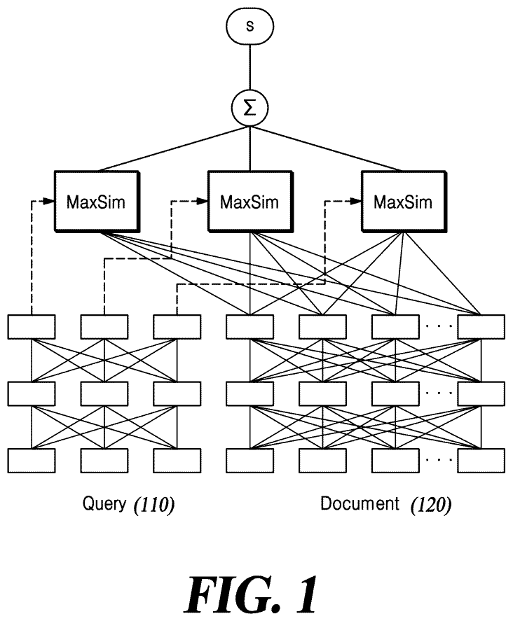

FIG. 1 is an exemplary diagram illustrating a method for searching multi-vector based on a ColBERT model.

Referring to FIG. 1, the ColBERT model includes a query 110 and a document 120.

When the query 110 and the document 120 are calculated together, a problem of an increased amount of computation occurs. Therefore, as shown in FIG. 1, the query 110 and the document 120 are computed separately.

The MaxSim score calculation method of FIG. 1 calculates a token-level score by performing a dot-product between each token vector of the query 110 and the document 120. However, the MaxSim score calculation method of FIG. 1 has a problem of large amount of computation.

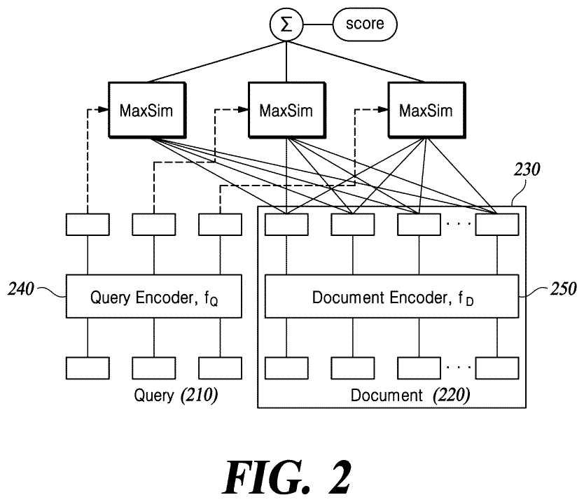

FIG. 2 is an exemplary diagram illustrating a MaxSim operation based on the ColBERT model.

### —Training Step—

\textcircled{1} Encode a given Query 210 and document 220 through a shared encoder.

\textcircled{2} Perform a MaxSim score calculation that represents a method for computing a document embedding (vector) having the highest similarity to a query embedding (vector), wherein the MaxSim score calculation method is as follows:
a dot-product is performed between the query token vector and the document token vector;
a maximum value is extracted from the document token vectors corresponding to each token vector in the query; and
all the extracted vectors are summed to represent the document, and the result of the MaxSim operation satisfies Mathematical Equation 1.

$$f ( Q , D ) = {\sum }_{i = 0}^{n} {\sum }_{i = 1}^{m} {A}_{ij} {q}_{i} {d}_{j} \qquad [ Mathematical Equation 1 ]$$

The result of the MaxSim operation represents f(Q, D) when Aᵢⱼ=1 and qᵢ, dⱼ have maximum value.

In Mathematical Equation 1, qᵢ represents the query token encoding vector (or query token vector), dⱼ represents the document token encoding vector, and Aᵢⱼ represents the maximum value masking vector.

Training is performed using cross entropy by setting pairs of query and document to be retrieved as positive samples and pairs of query and document that should not be retrieved as negative samples.

### —Indexing Step (Offline Indexing Step 230 of FIGS. 2)—

\textcircled{1} Use the document encoder of the trained model to generate a document token vector corresponding to a given collection.

\textcircled{2} Store token vectors generated for the entire collection as an index.

### —Retrieval Step—

\textcircled{1} Perform a retrieval based on the generated collection vector.

\textcircled{2} Generate a query vector using the query encoder of the trained model for a given query.

\textcircled{3} Perform a dot-product between the query vector and document vector and calculate a MaxSim score.

\textcircled{4} Extract a collection id having a highest score between the query and the collection.

### —Additional Processing—

\textcircled{1} The above method assumes that the length of the document is 512 tokens, and if the collection size is very large, indexing may become impossible.

\textcircled{2} Generally, a two-step search method is used, which consists of a retrieval step and a reranking step. In the retrieval step, an approximate nearest neighbor (ANN) search is performed. The retrieval step is a process of selecting candidates with high probability of having high scores, and ANN is essentially performed for fast retrieval step, and about 1000 document IDs are extracted through the retrieval step. Here, ANN is an algorithm for finding approximately nearest vectors and may find vectors very quickly.

Based on the extracted document IDs, candidate vectors are prepared by extracting corresponding vectors from the collection vector or by performing document encoding again using raw text of the corresponding documents. Thereafter, document reranking is performed by calculating MaxSim between the prepared 1000 document vectors and the given query vector.

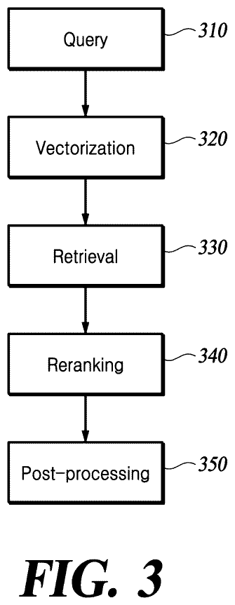

FIG. 3 is a flowchart illustrating a method for searching multi-vector using a span-level sequence compression technique according to an embodiment of the present disclosure.

An apparatus for searching multi-vectors using a span-level sequence compression technique receives a query as input from the user in step 310.

In step 320, the apparatus for searching multi-vectors using a span-level sequence compression technique converts the input query into a computable vector. The vectorization process of step 320 refers to a process of vectorizing meanings of words in order to understand the meaning of a natural language query input by the user and to provide a predetermined response.

In step 330, the apparatus for searching multi-vectors using a span-level sequence compression technique performs a similarity computation between the input query vectorized and a pre-generated collection index to retrieve candidate documents (retrieval step).

In step 340, the apparatus for searching multi-vectors using a span-level sequence compression technique performs reranking based on the retrieved candidate documents retrieved (reranking step).

In step 350, the apparatus for searching multi-vectors using a span-level sequence compression technique performs post-processing to extract text for the document ID.

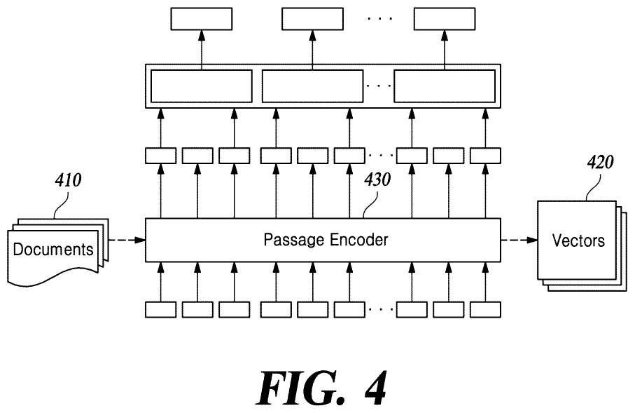

FIG. 4 is an exemplary diagram illustrating a process of indexing a collection according to an embodiment of the present disclosure.

More specifically, FIG. 4 illustrates the process of extracting embeddings from the collection using the model and indexing the embeddings.

The passage encoder 430 receives a given collection 410 as input. Here, the collection 410 refers to a set of documents.

The passage encoder 430 generates, for tokens of each document, vectors 420.

The retrieval step is a step of selecting candidates with high probability of high scores, and an indexing process needs to be performed for fast retrieval. For this purpose, vectors generated for each document are structured and stored together with document IDs.

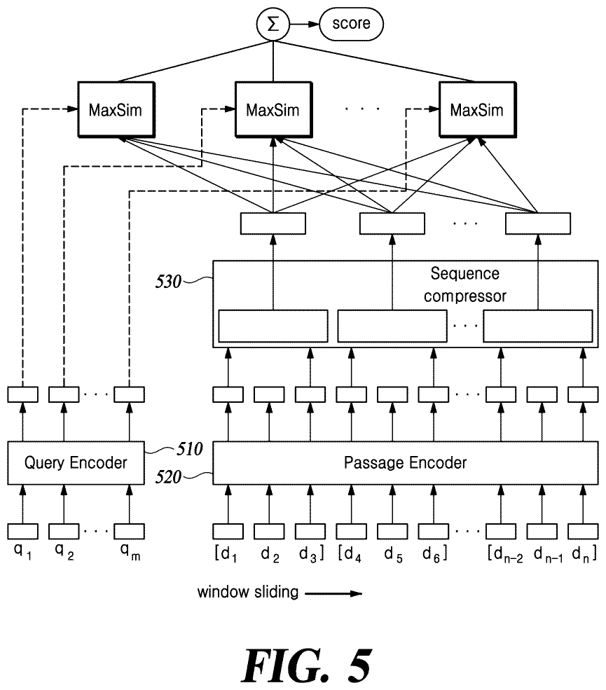

FIG. 5 is a structural diagram of an apparatus for searching multi-vector using a span-level sequence compression technique according to an embodiment of the present disclosure.

A model according to an embodiment of the present disclosure comprises a query encoder 510 that receives sentences of a query as input and a passage encoder 520 that receives sentences of a document as input.

An apparatus for searching multi-vectors using a span-level sequence compression technique according to an embodiment of the present disclosure comprises the query encoder 510, the passage encoder 520, a sequence compressor 530, a MaxSim score calculator 540, and the like.

The query encoder 510 and passage encoder 520 may use encoder-only models such as BERT, Robustly Optimized BERT Pretraining Approach (ROBERTa), and Efficiently Learning an Encoder that Classifies Token Replacements Accurately (ELECTRA).

In addition, the query encoder 510 and the passage encoder 520 may share one encoder or each use a different independent encoder.

The query encoder 510 encodes a given query token to generate a query token vector.

The passage encoder 520 encodes the given sentence token to generate a document token vector.

At this time, each sentence is tokenized through a tokenizer, and the tokenizer is a module used when performing tokenization. Tokenization refers to the operation of dividing a text corpus into meaningful elements such as words and phrases. Tokenization vectorizes the corpus by turning words according to the order of words in a dictionary.

The sequence compressor 530 generates spans for the tokens of the input document. Here, a span refers to the start and end positions of a token in a specific field, and is generated by window sliding based on span width and sliding step rate. When performing the window sliding operation, the window moves by the window sliding step, and a ratio that determines the window sliding step is referred to as the “sliding step rate”. A total number of spans generated through window sliding becomes the number of tensors used when indexing the document.

The sequence compressor 530 compresses the input document token vector into a span vector according to the generated span index. This means generating spans for the tokens of the input document through the process of compressing the input document token vector into a span vector.

The span vector according to an embodiment of the present disclosure includes a vector obtained by calculating the alignment scores of the start token, the end token, and the tokens included within the span range among the tokens corresponding to the span range, and concatenating them all together. The concatenated span vector may have its reduced dimensions through non-linear operations.

The MaxSim score calculator 540 performs a MaxSim operation between the generated query token vector and the generated span vector.

The result of the MaxSim operation for multi-vector search according to an embodiment of the present disclosure satisfies Mathematical Equation 2 below.

$$f ( Q , {D}^{s} ) = {\sum }_{i = 1}^{n} {\sum }_{k = 1}^{l} {A}_{ik} {q}_{i} {s}_{k} \qquad [ Mathematical Equation 2 ]$$

The result of the MaxSim operation represents f(Q, Ds) when Aᵢₖ=1 and qᵢ, sₖ have the maximum value.

The MaxSim score calculator 540 calculates a score corresponding to a query-document pair when Aᵢₖ is 1 and qᵢ, sₖ have the maximum value in the MaxSim function of Mathematical Equation 2.

In Mathematical Equation 2, qᵢ represents a query token encoding vector (or query token vector), sₖ represents a span vector, and Aᵢₖ represents a maximum masking vector.

The score calculated through Mathematical Equation 2 includes a score corresponding to a query-document pair (referred to as a “first score”).

The MaxSim score calculator 540 extracts the vector at the position of the first token (the [CLS] token) from the query token encoding vector and the document token encoding vector, and then performs a dot-product operation to calculate the document score corresponding to the single vector (referred to as the “second score”). Here, the [CLS (classification token)] token means a unique BERT token that has been trained to include the embedded information of the sequence when used in classification tasks using the embedded information of the sequence unit. An input of BERT includes sequences in sentence or paragraph units.

For training, the MaxSim score calculator 540 defines in-batch and pre-batch as negative samples, calculates the first score using a method of calculating the first score for each negative sample, and calculates the first loss value using cross-entropy.

The MaxSim score calculator 540 calculates a document score corresponding to a single vector using a method of calculating the second score, and calculates a second loss value using cross-entropy. In this case, in the training process, in-batch is defined as a negative sample.

The MaxSim score calculator 540 performs multi-task learning by adding the two calculated loss values (first loss value and second loss value).

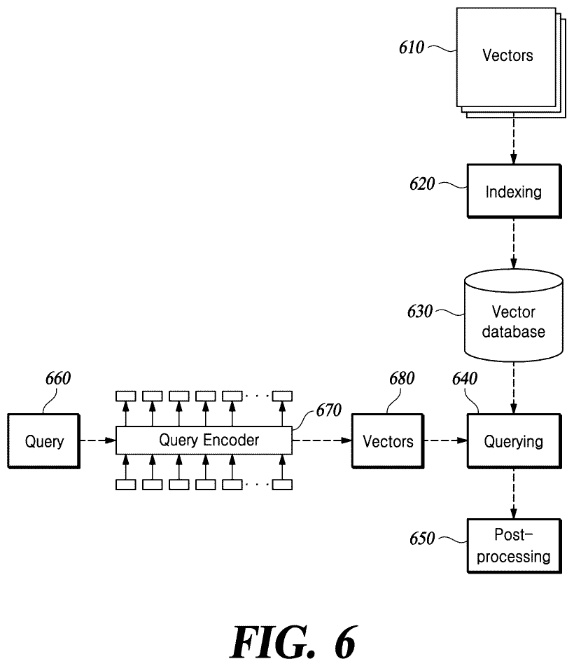

FIG. 6 is an exemplary diagram illustrating a search system pipeline to which a span-level sequence compression search model is applied according to another embodiment of the present disclosure.

FIG. 6 is an exemplary diagram illustrating a search system pipeline to which a search algorithm according to an embodiment of the present disclosure is applied.

An operation of FIG. 6 is performed by a pipelined processor of a search system to which the search algorithm according to an embodiment of the present disclosure is applied.

The processor generates a vector database 630 by indexing 620 each span vector generated through the document vectorization 610 described in FIG. 4. During the inference step of the search model, the processor loads a query encoder 670 of a trained model and the indexed vector database 630 to perform operations 640.

The processor generates a query token encoding vector 680 using the query encoder 670 for a query 660 input by the user.

In the querying step 640 of FIG. 6, the processor performs MaxSim operations based on the query token encoding vector 680 and all span vectors in the indexed vector database 630.

Then, in the querying step 640 of FIG. 6, the processor calculates the score of each document in the same manner as calculating the first score of FIG. 5 and applies the argmax function to all document scores to return the top-n search results along with the document ID.

Thereafter, in the post-processing step 650, the processor extracts the document text corresponding to the document ID and finally returns the document text to the user.

Various implementations of the systems and techniques described in this specification may be realized in digital electronic circuits, integrated circuits, field programmable gate arrays (FPGAs), application specific integrated circuits (ASICs), computer hardware, firmware, software, and/or combinations thereof. These various implementations may include being implemented as one or more computer programs executable on a programmable system. The programmable system includes at least one programmable processor (which may be a special-purpose processor or a general-purpose processor) coupled to receive data and instructions from, and transmit data and instructions to, a storage system, at least one input device, and at least one output device. Computer programs (also known as programs, software, software applications, or code) include instructions for the programmable processor and are stored on a “computer-readable recording medium”.

Computer-readable recording media include all types of recording devices that store data readable by a computer system. Such computer-readable recording media may be non-volatile or non-transitory media such as ROM, CD-ROM, magnetic tape, floppy disks, memory cards, hard disks, magneto-optical disks, and storage devices, and may further include transitory media such as data transmission media. Furthermore, the computer-readable recording media may be distributed across computer systems connected through a network so that computer-readable code is stored and executed in a distributed manner.

Various implementations of the systems and techniques described in this specification may be implemented by a programmable computer. Here, the computer includes a programmable processor, a data storage system (including volatile memory, non-volatile memory, or other types of storage systems, or a combination thereof), and at least one communication interface. For example, the programmable computer may be one of a server, network device, set-top box, embedded device, computer expansion module, personal computer, laptop, personal data assistant (PDA), cloud computing system, or mobile device.

The above description is merely illustrative of the technical spirit of the present embodiment, and it will be apparent to those skilled in the art that various modifications and changes may be made without departing from the essential characteristics of the embodiments. Therefore, the present embodiments are not intended to limit the technical spirit of the present embodiment but to illustrate the technical spirit, and the scope of the technical spirit of the present embodiment is not limited by such embodiments. The scope of protection of the present embodiment should be interpreted by the following claims, and all technical spirit within the equivalent scope thereof should be interpreted as being included in the scope of rights of the present embodiment.

What is claimed is:

1. An apparatus for searching multi-vector using a span-level sequence compression technique, comprising:
at least one memory storing instructions; and
at least one processor,
wherein the at least one processor configured to execute the instructions to:
generate a span comprising a span index for any document token;
encode an input query token to generate a query token encoding vector;
encode the document token to generate a document token encoding vector;
compress the document token encoding vector into a span vector according to the span index to output a compressed document token encoding vector; and
calculate a score between the query token encoding vector and the compressed document token encoding vector and retrieve a document token encoding vector having the highest similarity to the query token encoding vector.

2. The apparatus according to claim 1, wherein
the at least one processor is further configured to:
calculate a first loss value using cross-entropy on the score;
calculate a document score corresponding to a single vector;
calculate a second loss value using cross-entropy on the document score corresponding to the single vector; and
perform training by adding the first loss value and the second loss value.

3. The apparatus according to claim 2, wherein
the document score corresponding to the single vector is calculated by:
extracting, from the query token encoding vector and the document token encoding vector, vectors at a first token position; and
performing a dot-product on the extracted query token encoding vector and the extracted document token encoding vector.

4. The apparatus according to claim 1, wherein
the span is generated by performing window sliding according to span width and sliding step rate, and
the span index is generated based on a total number of the spans.

5. The apparatus according to claim 1, wherein
the number of the spans is configured to be equal to a number of tensors used when indexing the input document tokens.

6. The apparatus according to claim 1, wherein
the span vector comprises:
a vector obtained by calculating the alignment scores of the start token, the end token, and the tokens included within the span range among the tokens corresponding to the span range, and concatenating the calculated alignment scores.

7. The apparatus according to claim 1, wherein
the score is calculated using a MaxSim function, and
the MaxSim function satisfies the following mathematical equation:
$$f ( Q , {D}^{s} ) = {\sum }_{i = 1}^{n} {\sum }_{k = 1}^{l} {A}_{ik} {q}_{i} {s}_{k} \qquad [ Mathematical equation ]$$
where qᵢ represents the query token encoding vector, sₖ represents the span vector, and Aᵢₖ represents the maximum value masking vector.

8. The apparatus according to claim 7, wherein
the calculating the score comprises:
calculating a score corresponding to a query-document pair when, in the MaxSim function, Aᵢₖ is 1 and qᵢ, sₖ has a maximum value.

9. A computer-implemented method comprising:
generating a span comprising a span index for any document token;
encoding an input query token to generate a query token encoding vector;
encoding the document token to generate a document token encoding vector;
compressing the document token encoding vector into a span vector according to the span index to output a compressed document token encoding vector; and
calculating a score between the query token encoding vector and the compressed document token encoding vector and retrieving a document token encoding vector having the highest similarity to the query token encoding vector.

10. The computer-implemented method according to claim 9, further comprising:
calculating a first loss value using cross-entropy on the score;
calculating a document score corresponding to a single vector;
calculating a second loss value using cross-entropy on the document score corresponding to the single vector; and
performing training by adding the first loss value and the second loss value.

11. The computer-implemented method according to claim 10, wherein
the document score corresponding to the single vector is calculated by:
extracting, from the query token encoding vector and the document token encoding vector, vectors at a first token position; and
performing a dot-product on the extracted query token encoding vector and the extracted document token encoding vector.

12. The computer-implemented method according to claim 9, wherein
the span is generated by performing window sliding according to span width and sliding step rate, and
the span index is generated based on a total number of the spans.

13. The computer-implemented method according to claim 9, wherein
the number of the spans is configured to be equal to a number of tensors used when indexing the input document tokens.

14. The computer-implemented method according to claim 9, wherein
the span vector comprises:
a vector obtained by calculating the alignment scores of the start token, the end token, and the tokens included within the span range among the tokens corresponding to the span range, and concatenating the calculated alignment scores.

15. The computer-implemented method according to claim 9, wherein
the score is calculated using a MaxSim function, and
the MaxSim function satisfies the following mathematical equation:
$$f ( Q , {D}^{s} ) = {\sum }_{i = 1}^{n} {\sum }_{k = 1}^{l} {A}_{ik} {q}_{i} {s}_{k} \qquad [ Mathematical equation ]$$
where qᵢ represents the query token encoding vector, sₖ represents the span vector, and Aᵢₖ represents the maximum value masking vector.

16. The computer-implemented method according to claim 15, wherein
the calculating the score comprises:
calculating a score corresponding to a query-document pair when, in the MaxSim function, Aᵢₖ is 1 and qᵢ, sₖ has a maximum value.

17. A non-transitory computer-readable recording medium having instructions stored thereon, wherein the instructions, when executed by a computer, cause the computer to:
generate a span comprising a span index for any document token;
encode an input query token to generate a query token encoding vector;
encode the document token to generate a document token encoding vector;
compress the document token encoding vector into a span vector according to the span index to output a compressed document token encoding vector; and
calculate a score between the query token encoding vector and the compressed document token encoding vector and retrieve a document token encoding vector having the highest similarity to the query token encoding vector.
